(19) United States
(12) Patent Application Publication
(10) Pub. No.: US 2021/0058493 A1
(43) Pub. Date: Feb. 25, 2021

(54) CROSS-DOMAIN MAPPED COMPOUND NETWORK INSTRUCTION SYSTEM

(71) Applicant: Beijing Yi Zhang Yun Feng Technology Co., Ltd., Beijing (CN)

(72) Inventors: Qian Huang, Beijing (CN); Shaozhuang Liu, Beijing (CN); Junyan Liu, Beijing (CN); Yongsheng Yang, Shijingshan District (CN); Zicheng Wang, Haidian District (CN)

(21) Appl. No.: 17/044,141

(22) PCT Filed: Mar. 30, 2018
(86) PCT No.: PCT/CN2018/081300

§ 371 Date: Sep. 30, 2020

(51) Int. Cl. H04L 29/06; H04L 12/911; H04L 29/08

(52) U.S. Cl. CPC H04L 67/40; H04L 47/748; H04L 47/821; H04L 67/16; H04L 67/02; H04L 67/306; H04L 67/20; H04L 47/827

(57) ABSTRACT

Multiple input items from extensions of listened-to sites are received and stored in a common format for a given user. Compound conditions that are linked to the commonly formatted data can be analyzed and one or more mapped requests can be constructed from mappings. The mapped requests can then be transmitted to external sites for processing.

### TECHNICAL FIELD

The present disclosure generally relates to machines configured to the technical field of special-purpose machines that manage electronic communications over a network and improvements to such variants, and to the technologies by which such special-purpose machines become improved compared to other special-purpose machines for managing cross-domain mapped compound network instructions.

### BACKGROUND

In some network implementations, users log into network sites in different domains to perform various actions. For example, a user can log into a first site to interface with an accounting network application for the user's business, and log into a second site to access an inventory network application for said business. Some network sites allow the user to set up or run their application on their own private network. For example, the first site can install an instance of their accounting network application on the user's private network, for example, as part of an intranet. Further, some sites customize the application using a logo of the user's business and run a custom-branded instance of a given application on a sub-domain of the site. For example, the inventory network application can be branded with an “ACME” logo on a sub-domain of the second site (e.g., https://acme.secondsite.com). These different approaches allow users to efficiently use different work applications for various purposes without purchasing expensive hardware. However, managing the myriads of user accounts or instances on different network domains is burdensome because different sites often do not interface with each other. As such, users are often still required to log into various sites to perform functions. As the amount of data a given user manages increases (e.g., increased website traffic, increased inventory items to track, increased user-stored data, increase in inbound customer communications), forcing a user to log into multiple sites becomes increasingly inefficient and impractical.

### BRIEF DESCRIPTION OF THE DRAWINGS

Various ones of the appended drawings merely illustrate example embodiments of the present disclosure and should not be considered as limiting its scope.

FIG. 1 illustrates an example network architecture for implementing mapped compound instructions, according to some example embodiments.

FIG. 2 shows example configurations of event input items, according to some example embodiments.

FIG. 3 shows an example configuration of a cross-domain database, according to some example embodiments.

FIG. 4 shows a specification user interface, according to some example embodiments.

FIG. 5 shows an active set user interface, according to some example embodiments.

FIG. 6 shows example configurations of the generated mapped requests, according to some example embodiments.

FIG. 7 shows an example configuration for executing of the mapped compound instructions, according to some example embodiments.

FIG. 8 shows example functional components of a compound instruction system, according to some example embodiments.

FIG. 9 shows a flow diagram of a method for implementing mapped compound instructions, according to some example embodiments.

FIG. 10 shows an example flow diagram of a method for generating mapped compound instructions, according to some example embodiments.

FIGS. 11A-11B show example flow diagrams of a method for generating mapped requests from an active set, according to some example embodiments.

FIG. 12 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As discussed, forcing a user to access different network sites is problematic. To this end, a cross-domain mapped compound system can be implemented to efficiently generate complex network actions in response to network events. In particular, for example, extensions are integrated into network sites to passively listen for events. The extensions transmit unified event input items over a network (e.g., the Internet) to a mapped instruction system hosted on a server. The unified event input items are log items in a common format that have been customized for the network sites. While each of the listened-to network sites may be configured to different purposes (e.g., an accounting application, a database application, website hosting software), the common format of the unified event input items allows the mapped instruction system to perform complex actions that can be efficiently specified by a user without manually logging into or otherwise accessing each of the network sites individually.

In particular, for example, the mapped instruction system generates a user interface which allows the user to specify one or more parameters (e.g., metadata, properties, tags, keywords) and conditions linked to the parameters. The user interface further enables the user to specify one or more network actions that occur in response to a condition being satisfied. The network actions can be network actions that are to occur on external sites (e.g., sites on a domain different from the domain on which the mapped instruction system is hosted, sites on domains different than the domains on which the listened-to sites are hosted).

Each action available in the user interface has a stored mapping that correlates values from the unified event input items to a network request configured for a given external site (e.g., an application programming interface (API) of the given external site). Different sites can have different APIs which require differently formatted network requests. Each mapping can be used pre-emptively to handle the differently formatted network requests for that user's external sites upon a condition or compound condition being satisfied.

The user interface allows multiple conditions for multiple parameters to execute multiple actions on different network sites, as discussed in further detail below with examples. Each of the existing mapped compound instruction can be displayed in a further user interface from which the user can activate or deactivate each specified mapped compound instruction. As used below, a “specified” mapped compound instruction is an existing compound instruction that has been configured and saved through the user interface. In some example embodiments, only properties specified in an active set of mapped compound instructions are processed. That is, for example, instead of analyzing all data received in the input items, the mapped instruction system determines whether any of the received data items include a parameter that matches a parameter in the active set of mapped compound network instructions. Upon a matching parameter being identified, the linked condition is evaluated and multiple network actions executed accordingly. In this way, users can use prespecified conditions and data values to efficiently complete network operations across domains that are not configured to interface with one another.

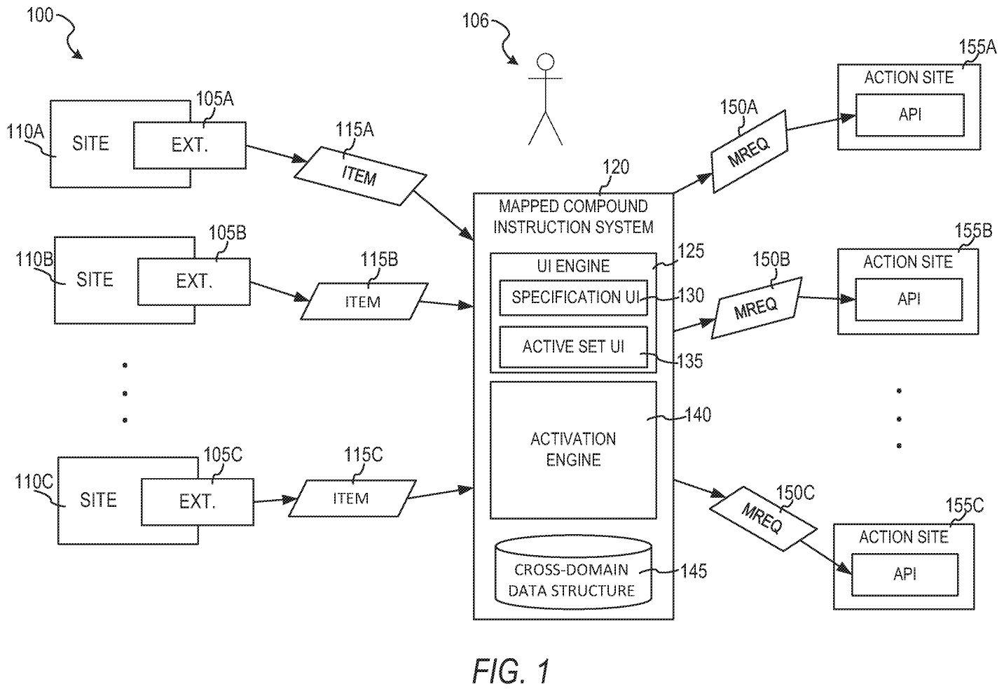

FIG. 1 illustrates an example network architecture 100 for implementing mapped compound instructions, according to some example embodiments. As illustrated, extensions 105A-105C are integrated into respective network sites 110A-110C (e.g., listened- to sites). The extensions 105A-105C are configured to passively listen for network events on sites 110A-110C. In some example embodiments, the extensions 105A-105C can be configured as site plug-ins that are integrated into the back ends of sites 110A-110C. They are configured to generate unified event input items 115A-115C in response to events occurring on the sites 110A-110C. For example, if site 110A hosts a customer relation management (CRM) network application, extension 105A can be configured to generate unified input item 115A in response to a CRM network application event. For instance, if the CRM network application receives an email with a keyword “@acmecorp.com” in the address, the extension 105A activates within site 110A and sends the unified input item 115A to system 120. In the example, item 115A can include metadata that describes the email, when the email was received, user data, as well as property values, such as the email message content.

Continuing the example, site 110B may host an IP telephony application. In response to a call ending, starting, or other event, extension 105B constructs and transmits item 115B to system 120. Additional sites and extensions can generate additional items in a similar manner. In some example embodiments, each site that has an extension to generate unified event input items is a site on which a user 106 has an account. The metadata of the items 115A-115C indicate the identity of the user 106 and other user data (e.g., token, passwords) that system 120 can use to store the items 115A-115C in a cross-domain data structure 145 for that user 106. In other words, in FIG. 1 items 115A-115C may all pertain to the same user 106 who has user accounts on all the sites 110A-110C. Additional users (not depicted) may have their cross-domain data tracked in a similar manner on some or all of the same sites or other sites (e.g., each user can specify which sites he/she has a user account on, for which extensions can generate commonly formatted data to be stored by system 120 for processing.)

Although the extensions 105A-105C are discussed in the above example as plug-ins integrated into the framework of respective network sites, in some example embodiments, the extensions 105A-105C operate as polling extensions external to the sites 110A-110C. That is, the extensions can be hosted within system 120 and periodically poll APIs of sites 110A-110C to generate the items 115A-115C, which can then be stored in the cross-domain data structure 145 for that user.

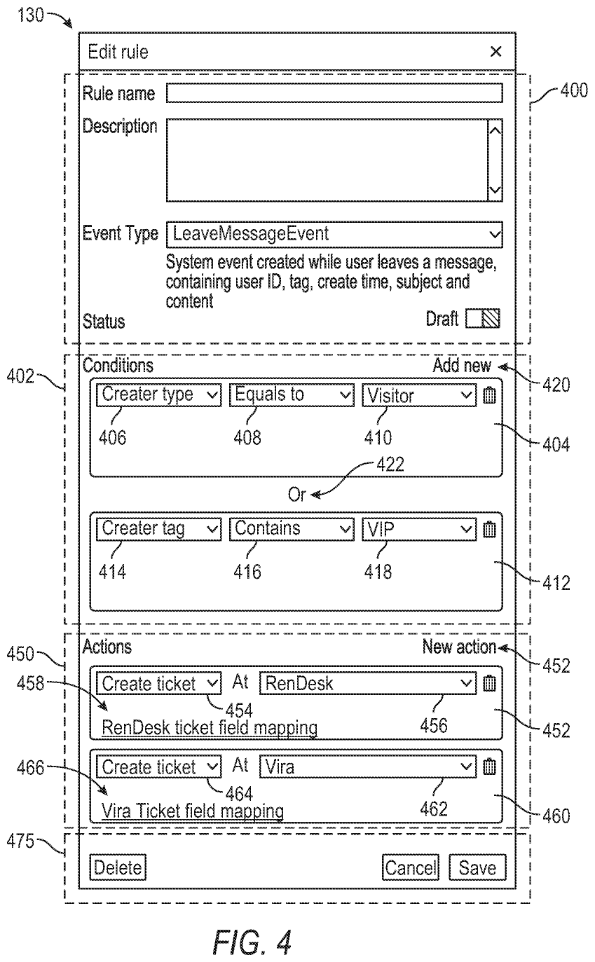

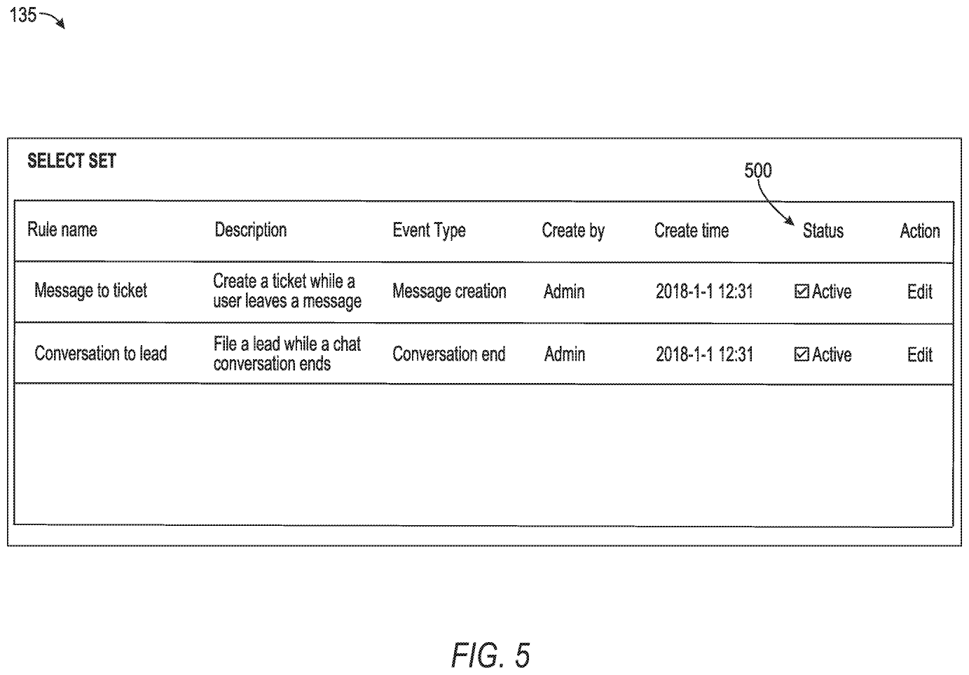

In some example embodiments, the mapped instruction system 120 includes a user interface engine 125 which generates a specification user interface 130 and an active set user interface 135. The specification user interface 130 is configured to allow a user 106 to efficiently generate mapped compound instructions, as discussed in further detail below, with reference to FIG. 4. The active set user interface 135 is configured to allow the user 106 select which of the mapped compound instructions are included in the active set, as discussed in further detail below with reference to FIG. 5.

The conditions and parameters specified by the mapped compound instructions in the active set can be continuously analyzed by an activation engine 140 to identify matching parameters. Upon a parameter of a given unified event input item satisfying a linked condition, the activation engine 140 uses a mapping to extract parameter data stored in the data structure 145 and generate one or more mapped requests.

Each of the mapped requests can be structured network requests that are transmitted to one or more external sites for execution. For example, as illustrated in FIG. 1, in response to one or more received data (e.g., parameter data of the unified event input items 115A-115C) satisfying linked conditions, the activation engine 140 uses mappings and parameter data to generate multiple mapped requests 150A-C.

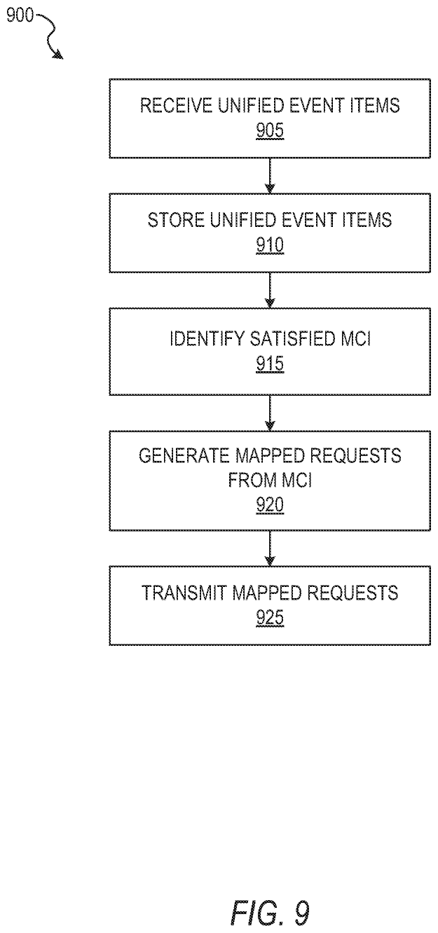

The mapped requests 150A-150C are transmitted to external sites 155A-155C for implementation. In particular, mapped request 150A is sent to an API of action site 155A, mapped request 150B is sent to the API of action site 155B, and mapped request 150C is sent to the API of the action site 155C. In some example embodiments, the mapped compound instructions may include feedback mechanisms that further generate mapped requests in response to receiving data from the action sites, as discussed in further detail below with reference to FIG. 9.

In some example embodiments, system 120 is a computing device that includes at least a display and communication capabilities to access sites 110A-110C and action sites 155A-155C via a network (e.g., the Internet). For example, the computing device on which system 120 functions can include but is not limited to: a remote device, work station, computer, general purpose computer, Internet appliance, hand-held device, wireless device, portable device, wearable computer, cellular or mobile phone, Personal Digital Assistant (PDA), smart phone, tablet, netbook, laptop, desktop, multi-processor system, microprocessor-based or programmable consumer electronic, game consoles, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The networks through which system 120 accesses the site, extensions, and/or databases (e.g., cross-domain data structure 145) include an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof.

A user 106 comprises a person, a machine, or other means of interacting with the computing device. In some example embodiments, the user 106 is not part of the network architecture 100, but interacts with the network architecture 100 via system 120 or another means. For instance, the user 106 provides input (e.g., touch screen input or alphanumeric input) to system 120.

Further, while the client-server-based network architecture 100 shown in the example of FIG. 1, the present subject matter is, of course, not limited to such an architecture, and can equally well find application in a distributed, or peer-to-peer, architecture system, for example. The various systems of system 120 can also be implemented as standalone software programs, which do not necessarily have networking capabilities.

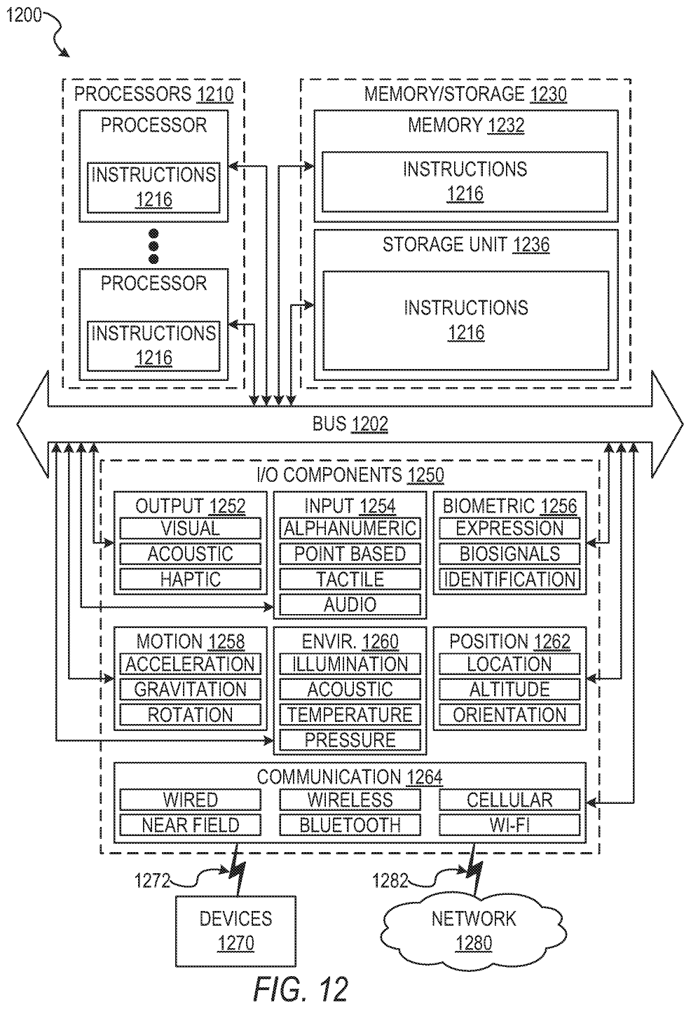

It is noted that the network architecture 100 shown in FIG. 1 is merely an example. For instance, any number and types of the user devices may be embodied within the network architecture 100. Additionally, some components of the network architecture 100 may be combined. Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 12. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines. Moreover, any two or more of the systems or machines illustrated in FIG. 1 may be combined into a single system or machine, and the functions described herein for any single system or machine may be subdivided among multiple systems or machines.

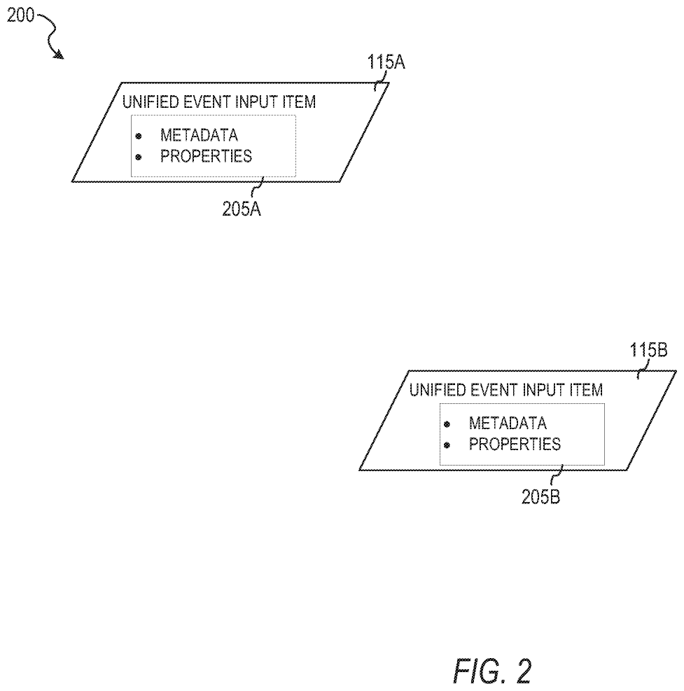

FIG. 2 shows example configurations 200 of unified event input items, according to some example embodiments. As illustrated, unified event input items 115A and 115B can include parameter data 205A and 205B in a common format. For example, parameter data can comprise metadata fields and property fields. The metadata fields describe a type of event that occurred on a listened-to site (e.g., sites 110A-C) or information about the communication, such as the username, message type, and so on. Properties fields can store substantive payload data that describes the event that occurred on a given listened-to site, message data (e.g., email message, call data), CRM issue data, and/or custom tags. An example structure for parameter data 205A includes:

- event:
{
“meta_eventId”: “ca81ade0-6dc5-11e6-9c13-dfa1eed70626”,
“ meta_timeStamp”: 1472460726612,
“ meta_eventType”: “Message create”,
“properties”: {

“Message” : {
“Creator” : ,
“Creator Type” : ,
“Creator tag” : ,
“Phone” : ,
“Mail”,
“Channel”,
“Create time” : ,
“Update time” : ,
“Subject”:,
“Content”:,

}

}

}

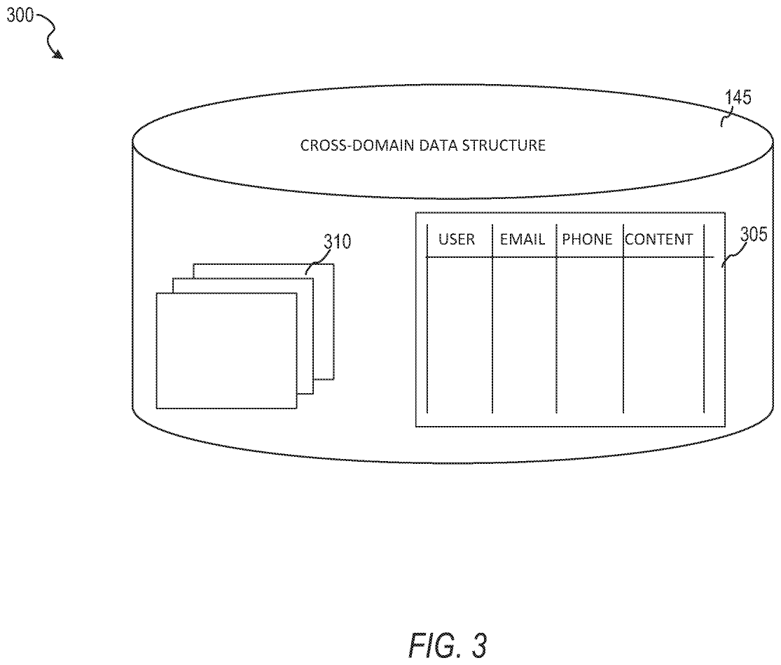

FIG. 3 shows an example configuration 300 of a cross-domain data structure 145, according to some example embodiments. The cross-domain data structure 145 is structured to receive parameter data from the unified event input data items of the plurality of sites. The cross-domain data structure 145 can store user data in a common format, such as table 305 having schema that is configured for all of the parameters of the unified event input items for that user (e.g., user 106). Input items generated by the extensions for other users can be stored in other tables having a common format (e.g., tables 310).

FIG. 4 shows a specification user interface 130, according to some example embodiments. As illustrated, the specification user interface 130 includes a description window 400 which has one or more fields configured to describe mapped compound instructions being generated or edited. Further, according to some example embodiments, the specification user interface 130 includes a compound condition window 402 for linking conditions to parameter fields. As illustrated, the compound condition window 402 can be used to specify multiple conditions that act in concert to trigger actions specified in the action window 450. In the example of FIG. 4, a compound condition includes two conditions: linked condition element 404 and linked condition element 412.

Linked condition element 404 includes a property field selector 406 with a value of “Creator type”, a condition selector 408 with a value of “equals to”, and a property value selector 410 with a value of “visitor”. The linked condition element 404 thus creates a condition that is true if the creator type field from an input item is equal to the data value of “visitor”. Similarly, linked condition element 412 includes a property field selector 414 with a value of “Creator tag”, a condition selector 416 with a value of “contains”, and a property value selector 418 with a value of “VIP”. The linked condition element 412 thus creates a condition that is true if the creator tag field (a custom tag created by an extension) contains the string “VIP”. The two elements are linked by a Boolean condition 422 of “OR”, which can be changed by clicking and selecting a condition from a list (e.g., OR, AND).

In the example illustrated, property selector elements (e.g., property field selector 406) can include a plurality of options that are displayed as a drop-down menu, according to some example embodiments.

The properties that are selectable in the drop down menu of property field selector 406 or 414 can be any property field received in a unified event input item. For example, as discussed above, an input item can include the following property fields, each of which can be selectable through a property field selector: message, creator, creator type, creator tag, phone, mail, channel, create time, update time, subject, content. The underlying values of the property field can be specified by property value selector elements, such as property value selector 410.

The property value selector includes options for the underlying value of a property field. For example, a property field can be “customer type” and a value of the that property field can be “VIP” or “Acme Corp.”

Similarly, condition selector elements (e.g., condition field selector 408 and 416) can include a plurality of options that are displayed as a drop-down menu, according to some example embodiments. The conditions that are selectable in the drop down menu of a condition field selector can include conditions that are congruent with the types of property fields and values upon which the conditions operate. Example conditions can include: matches, is, contains, includes equals to, more than, less than, more than or equal to, less than or equal to, earlier than, equals to, and later than. In this way, property field/values can be customized for the sites being listened to, and the condition options can be customized to be congruent with the property fields. Thus a user can use interface 130 to create complex conditional triggers.

Additional linked condition elements can be added via “Add New” link 420 to create a more complex compound condition. Further examples of specified link condition elements include:

| # | Prop. Field | Condition | Prop. Value |
|---|---|---|---|
| 1 | Creator | Contains | Admin |
| 2 | Phone | Contains | 208 |
| 3 | Subject | Contains | Urgent |
| 4 | Channel | Is | Email |
| 5 | Create Time | Earlier Than | Mar. 23, 2016 |
| 6 | Content | Larger than | 25 Mb |
| 7 | Content Type | Is | .PNG file |
| 8 | Payment | Larger than | $10,000 |

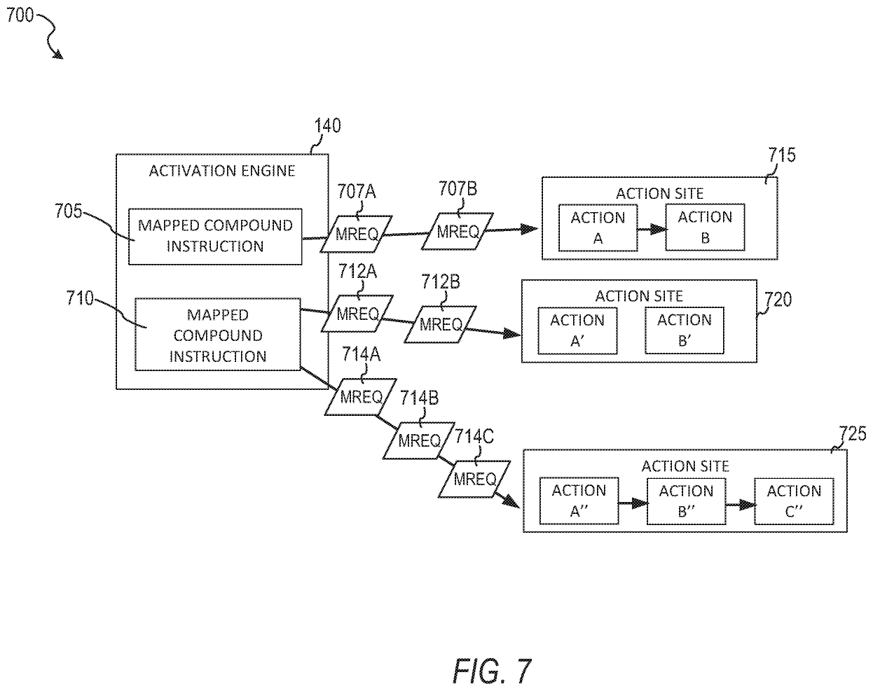

The specification user interface 130 further comprises an action window 450 that can be used to specify what actions are performed in response to being triggered by the compound conditions from window 402. As illustrated, action window 450 includes two action elements 453 and 460, which are configured to generate mapped requests, as discussed below with reference to FIG. 5. The first action element 453 has an action selector 454 that selects a type of mapped request to be generated and sent to a site selected by site selector 456. The mapping element 458 is operable to map data from the cross-domain data structure 145 to the API required by the site selected by site selector 456. Likewise, a second action element 460 specifies a simultaneous action specified by action selector 464 to be executed to a site specified by site selector 462. Further, the mapping element 466 is operable to map data from the cross-domain data structure 145 (e.g., user data of user 106) to the API format specified by the site selected by site selector 462. Additional action elements to be trigged upon conditions being satisfied can be added with New Action button 452. Examples of how actions can be performed is further discussed below, with reference to FIG. 7.

Upon the fields being selected or otherwise populated by a user 106, the control elements 475 allow the user 106 to cancel changes, delete the mapped compound instruction, or save the mapped compound instruction.

FIG. 5 shows an active set user interface 135, according to some example embodiments. The active set user interface 135 displays a table having one or more entries (e.g., rows) of existing mapped compound requests generated using the specification user interface 130. The active set user interface 135 includes user interface selection buttons 500, each of which is operable to include or exclude a given mapped compound instruction (e.g., in a given row) from being included in the active set.

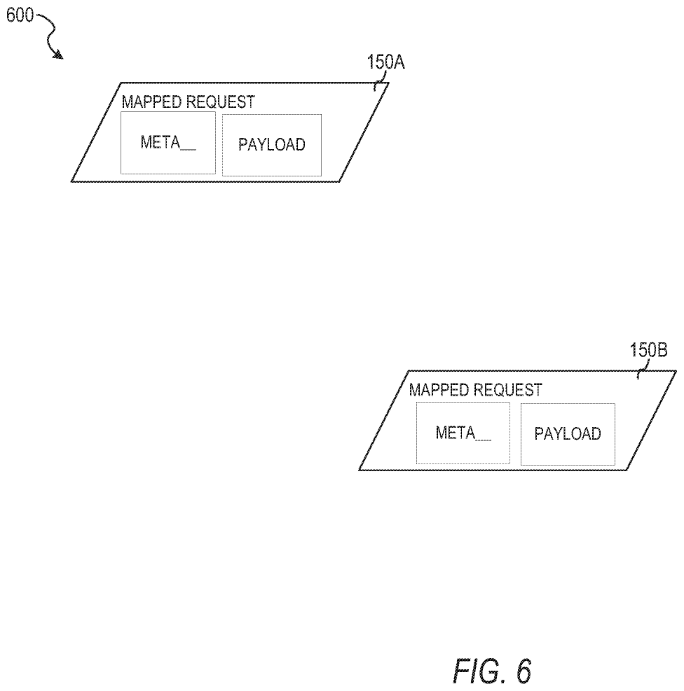

FIG. 6 shows example configurations of the generated mapped requests, according to some example embodiments. Each mapped request 150A, 150B is generated in response to a given condition (e.g., individual condition) or compound condition (e.g., two or more conditions) of a mapped compound instruction being satisfied. The mapped requests 150A, 150B include an API payload which is specified using the mappings of a given action. For example, the mapped compound instruction generated by user interface 130 can be as shown below.

“actions”: [
{

“meta_type”: “restAction”,
“ meta_parameterValues”: {
“ meta_url”: “https://your_subdomain.rendesk.com/api/v2/groups.json”,

//create ticket at Rendesk

“ meta_method”: “POST”,
“ meta_headers”: {“content-type”:“application/json;UTF-8”},
“ meta_queryParams”:{“userName”:“your_email_address”,

“pwd”:“your_password”},

“PAYLOAD”: {“ticket”: {“subject”: “My printer is on fire!”, “comment”:

{“body”: “The smoke is very colorful.”}}}

}

}
{

“ meta_type”: “restAction”,
“ meta_parameterValues”: {
“ meta_url”: “https://<VIRA_HOST>/rest/api/2/issue/”, //create ticket at

Jira

“ meta_method”: “POST”,
“ meta_headers”: {“content-type”:“application/json;UTF-8”},
“ meta_queryParams”:{“userName”:“your_email_address”,

“pwd”:“your_password”},

“ PAYLOAD”: {

“fields”: {
“project”:

{

“key”: “<PROJECT_KEY>”

},

“summary”: “REST EXAMPLE”,
“description”: “Creating an issue via REST API”,
“issuetype”: {

“name”: “Bug”

}

}

}

}

}
]

In some example embodiments, the activation engine 140 uses the metadata portions to transmit the payload to a specified action site. Further, in some example embodiments, the activation engine 140 transmits both the metadata portions (e.g., password, key data) and the payload message to the action sites for external processing.

FIG. 7 shows an example configuration 700 for execution of the mapped compound instructions, according to some example embodiments. As discussed above, an individual mapped request instruction can cause execution of different actions on the same network site or different network sites. For example, in FIG. 7, mapped compound instruction 705 can generate two mapped requests, which are sent to an API of action site 715 for processing. For example, the first mapped request 707A performs a first action A and the second mapped request 707B performs a second action B. In some embodiments, both mapped requests 707A, 707B are sent out without sequencing and the action site 715 performs action A after action B. In some example embodiments, the second mapped request 707B is not transmitted until a confirmation that first mapped request 707A is received by the activation engine 140.

Further, mapped compound instructions created through the user interface 130 can cause multiple simultaneous actions on different sites. For example, mapped compound instruction 710 can generate first and second mapped request items 712A and 712B, which instruct action site 720 to perform action A′ and action B′ in any order (e.g., action B′ before action A′ or vice versa). At approximately the same time, the mapped compound instruction 710 further generates mapped requests 714A-714C to perform action A″, action B″, and action C″ in sequence on action site 725. Further, as discussed below, the mapped compound instructions may include feedback mechanisms in which further mapped requests are generated in response to receiving data from the action sites, as discussed in further detail below.

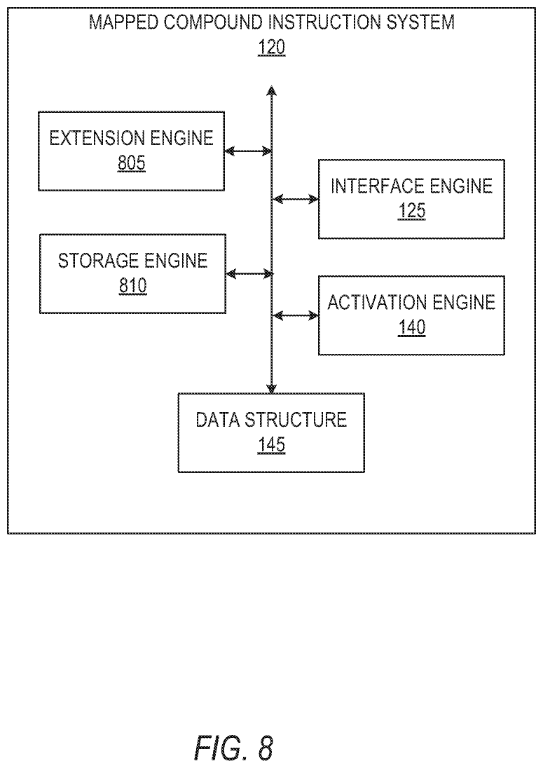

FIG. 8 shows example functional components of a mapped compound instruction system 120, according to some example embodiments. The components themselves are communicatively coupled (e.g., via appropriate interfaces) to each other and to various data sources, so as to allow information to be passed between the applications or so as to allow the applications to share and access common data. As illustrated, the mapped compound instruction system 120 includes an extension engine 805, a storage engine 810, a user interface engine 125, an activation engine 140, and data structure 145.

The extension engine 805 is configured to interface with extensions integrated in listened-to sites, according to some example embodiments. Further, if the listened-to sites cannot be configured to use integrated plugins but have APIs, the extension engine 805 can poll the APIs of the listened-to-sites for input data. The storage engine 810 is configured to store data in the data structure 145 and retrieve the data to generate mapped requests according to mappings. The interface engine 125 manages generation of user interfaces (e.g., specification UI 130 and active set UI 135) that are used to generate and manage mapped compound instructions. The activation engine 140 manages evaluating parameters in the active set (i.e., determining whether the parameters satisfy linked conditions), and transmits one or more mapped requests to action sites for processing, as discussed above. Any one or more of the components (e.g., engines) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that component. Accordingly, different components described herein may include and configure different arrangements of the processors at different points in time or a single arrangement of the processors at different points in time. Each component (e.g., engine) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices.

FIG. 9 shows a flow diagram of a method 900 for implementing mapped compound instructions, according to some example embodiments. Operations in the method 900 may be performed by system 120, using components (e.g., engines) described above with respect to FIGS. 1 and 8. Accordingly, the method 900 is described by way of example with reference to system 120. However, it shall be appreciated that at least some of the operations of the method 900 may be deployed on various other hardware configurations or be performed by similar components residing elsewhere. Therefore, the method 900 is not intended to be limited to system 120.

At operation 905, the extension engine 805 receives unified event items from extensions integrated into external network sites. For example, an extension 105A generates item 115A and transmits it to extension engine 805.

At operation 910, the storage engine 810 stores the received unified event items. For example, the storage engine 810 stores items 115A-C in data structure 145. At operation 915, the activation engine 140 identifies one or more parameters that satisfy linked conditions. For example, the activation engine 140 determines that a property value of “email” satisfies the linked condition of “channel type is . . . ”, as discussed above. At operation 920, the activation engine 140 generates the mapped requests according to respective mapped compound instructions. For example, the activation engine 140 generates the mapped request actions above. At operation 925, the activation engine 140 transmits the generated mapped requests to one or more external sites, such as action sites 155A-155C.

Further, in some example embodiments, after operation 925 the activation engine 140 may receive one or more communications from the actions sites 155A-155C which the activation engine 140 may use to perform further actions. For example, a mapped request may be a request for data from an action site. When the requested data is received by the action engine 140 it may perform additional actions and transmit additional mapped requests. As an example, a unified input item be received in response to a IP telephone call ending on a given listened-to site. Responsive to the input item, the action engine 140 may transmit a mapped request to an action site requesting user data of the user on the IP telephone call. When the user data is received from the activation engine 140 the activation engine may then construct and transmit an additional mapped request if the user data meets a linked condition. For example, if user data received from the action site specifies that the user is a platinum tier type, an additional mapped request can be sent to another action site to perform additional actions. For instance, if the user is a platinum tier type, an additional mapped request can be sent to a email server of an action site that sets a follow up electronic message to be sent to the user in one month from the end of the IP telephone call. In this way, mapped requests form a feedback mechanism that delineates further actions that may be executed upon pre-specified conditions being satisfied.

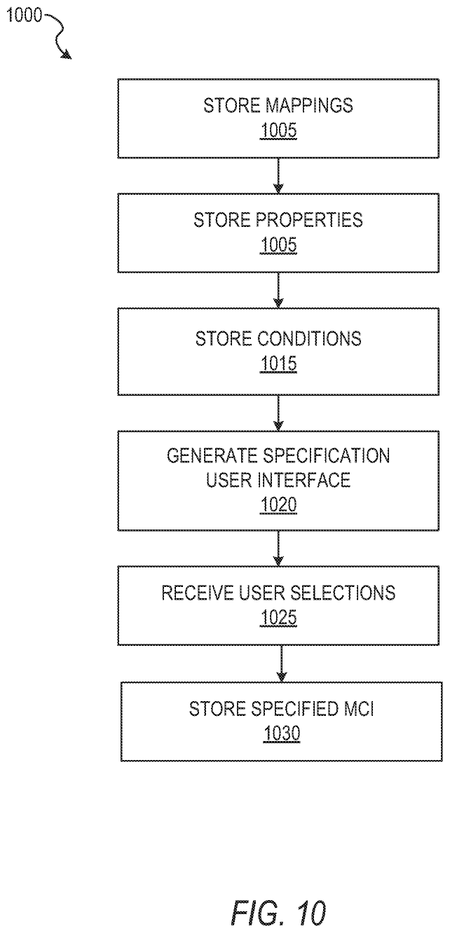

FIG. 10 shows an example flow diagram of a method 1000 for generating mapped compound instructions, according to some example embodiments. Operations in the method 1000 may be performed by system 120, using components (e.g., engines) described above with respect to FIGS. 1 and 8. Accordingly, the method 1000 is described by way of example with reference to system 120. However, it shall be appreciated that at least some of the operations of the method 1000 may be deployed on various other hardware configurations or be performed by similar components residing elsewhere. Therefore, the method 1000 is not intended to be limited to system 120.

At operation 1005, the interface engine 125 stores mappings for different action sites. For example, a first mapping may be edited using a link (e.g., mapping element 458 in FIG. 4) to construct the payload of mapped request 150A, discussed above with reference to FIG. 6. Each site to which mapped requests are to be sent can have a mapping stored at operation 1005.

At operation 1010, the interface engine 125 stores available properties that are selectable using the parameter selector UI elements (e.g., selectors 406 and 410 of FIG. 4). At operation 1015, the interface engine 125 stores one or more conditions that can be linked to one or more parameters as linked conditions (e.g., conditions specified by 408 and 416 in FIG. 4).

At operation 1020, the interface engine 125 generates a specification user interface 130 using the available selections set by operations 1005-1015. At operation 1025, the interface engine 125 receives user selections made through the specification user interface 130. For example, the user 106 selects the conditions, parameters, and actions as shown in FIG. 4. At operation 1030, the user interface engine 125 stores a specific mapped compound instruction according to the selections received at operation 1025. After method 1000 is complete, a specific mapped compound instruction is stored in memory of system 120 and the activation engine 140 can analyze data in data structure 145 to conditionally execute actions, as discussed above.

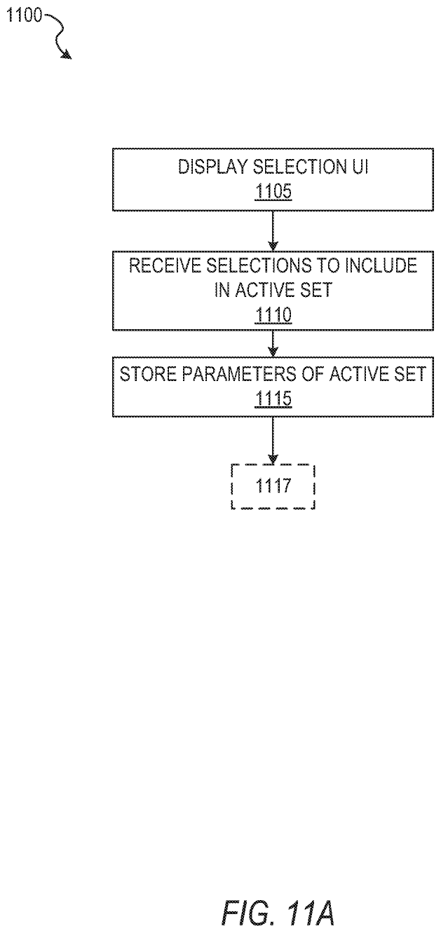

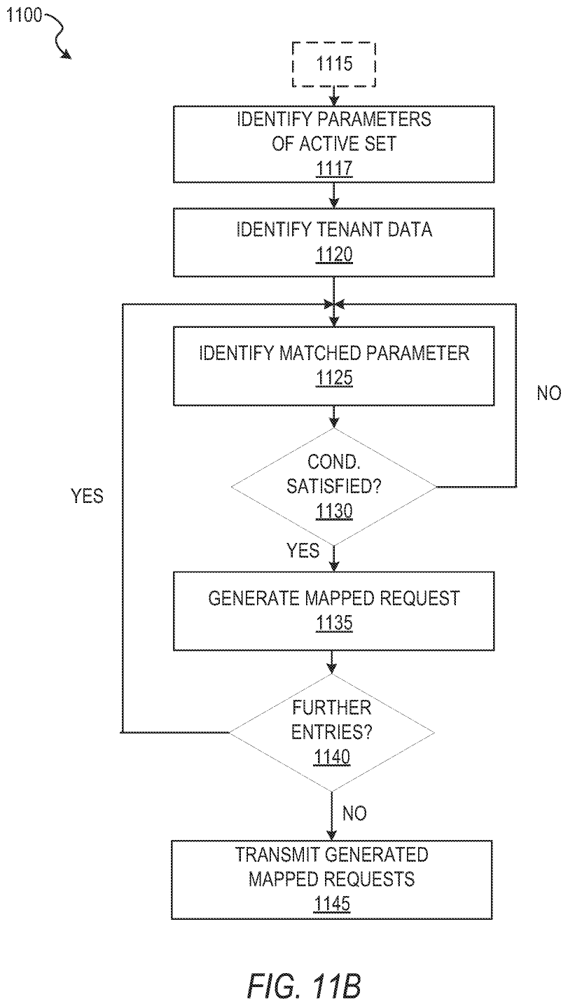

FIGS. 11A-11B show example flow diagrams of a method 1100 for generating mapped requests from an active set, according to some example embodiments. Operations in the method 1100 may be performed by system 120, using components (e.g., engines) described above with respect to FIGS. 1 and 8. Accordingly, the method 1100 is described by way of example with reference to system 120. However, it shall be appreciated that at least some of the operations of the method 1100 may be deployed on various other hardware configurations or be performed by similar components residing elsewhere. Therefore, the method 1100 is not intended to be limited to the system 120.

At operation 1105, the interface engine 125 displays a selection user interface. For example, at operation 1105 the interface engine 125 displays the active set user interface 135 of FIG. 5.

At operation 1110, the interface engine 125 receives selections of which mapped compound instructions to include in the active set. For example, at operation 1110, the interface engine 125 receives selections of one or more UI selection buttons 500 in the active set user interface 135. At operation 1115, the interface engine 125 stores parameters of the mapped compound instructions included in the active set.

Continuing to FIG. 11B, at operation 1117 the activation engine 140 identifies parameters of the mapped compound instructions in the active set. At operation 1120, the activation engine 140 identifies user data. For example, at operation 1120, the activation engine 140 identifies the user data or stored in the cross-domain data structure 145, e.g., in the table 305.

At operation 1125, the activation engine 140 identifies a matched parameter. For example, if one of the input items has a creator property field with a value of VIP, the matching parameter would be “VIP”, as shown in element 412 in FIG. 4.

At operation 1130, the activation engine 140 determines whether the matched parameter satisfies a linked condition. If the matched parameter does not satisfy the linked condition, then the method 1100 returns to operation 1125, where additional matched parameters can be identified. Alternatively, if the matched parameter satisfies the linked condition at operation 1130, then the activation engine 140 generates, at operation 1135, the mapped request according to the one or more actions specified in the specification user interface 130.

At operation 1140, the activation engine 140 determines whether there are any further entries of tenant data to be searched for matching parameters. Assuming there are additional entries for analysis, the activation engine 140 continues to operation 1125 where additional matching parameters are identified. On the other hand, if there is no further user data for analysis, the method 1100 continues to operation 1145, where the activation engine 140 transmits the generated mapped requests to one or more external network sites (e.g., action sites 155A-C).

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. As such, the instructions 1216 may be used to implement modules or components described herein. The instructions 1216 transform the general, non-programmed machine 1200 into a particular machine 1200 programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by the machine 1200. Further, while only a single machine 1200 is illustrated, the term “machine” shall also be taken to include a collection of machines that individually or jointly execute the instructions 1216 to perform any one or more of the methodologies discussed herein.

The machine 1200 may include processors 1210, memory/storage 1230, and I/O components 1250, which may be configured to communicate with each other such as via a bus 1202. The memory/storage 1230 may include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 may also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of the processors 1210 are examples of machine-readable media.

The I/O components 1250 may include a wide variety of components to receive input, provide output, produce output, transmit information, exchange information, capture measurements, and so on. The specific I/O components 1250 that are included in a particular machine 1200 will depend on the type of machine. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion and the grouping is in no way limiting. In various example embodiments, the I/O components 1250 may include output components 1252 and input components 1254. The output components 1252 may include visual components (e.g., a display such as a plasma display panel (PDP), a light-emitting diode (LED) display, a liquid-crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1250 may include biometric components 1256, motion components 1258, environment components 1260, or position components 1262 among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1258 may include acceleration sensor components (e.g., accelerometer), gravitation sensor components, rotation sensor components (e.g., gyroscope), and so forth. The environment components 1260 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 1262 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via a coupling 1282 and a coupling 1272 respectively. For example, the communication components 1264 may include a network interface component or other suitable device to interface with the network 1280. In further examples, the communication components 1264 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a Universal Serial Bus (USB)).

Moreover, the communication components 1264 may detect identifiers or include components operable to detect identifiers. For example, the communication components 1264 may include radio frequency identification (RFID) tag reader components, NFC smart tag detection components, optical reader components (e.g., an optical sensor to detect one-dimensional barcodes such as Universal Product Code (UPC) barcode, multi-dimensional barcodes such as Quick Response (QR) code, Aztec code, Data Matrix, Dataglyph, MaxiCode, PDF412, Ultra Code, UCC RSS-2D barcode, and other optical codes), or acoustic detection components (e.g., microphones to identify tagged audio signals). In addition, a variety of information may be derived via the communication components 1264, such as location via Internet Protocol (IP) geolocation, location via Wi-Fi® signal triangulation, location via detecting an NFC beacon signal that may indicate a particular location, and so forth.

### Glossary

“COMMUNICATIONS NETWORK” in this context refers to one or more portions of a network 1380 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network 1380 may include a wireless or cellular network and the coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

EXECUTABLE INSTRUCTIONS AND MACHINE-STORAGE MEDIUM in this context includes various memories (i.e., and/or memory of the processor(s)) and/or storage unit may store one or more sets of instructions and data structures (e.g., software) 624 embodying or utilized by any one or more of the methodologies or functions described herein. These instructions, when executed by processor(s) cause various operations to implement the disclosed embodiments.

Further, as used herein, the terms “machine-storage medium,” “device-storage medium,” “computer-storage medium” (referred to collectively as “machine-storage medium”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically exclude carrier waves, modulated data signals, and other such media, at least some of which are covered under the term “signal medium” discussed below.

SIGNAL MEDIUM—The term “signal medium” or “transmission medium” shall be taken to include any form of modulated data signal, carrier wave, and so forth. The term “modulated data signal” means a signal that has one or more of its characteristics set or changed in such a matter as to encode information in the signal.

COMPUTER READABLE MEDIUM—The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

COMPONENT—Refers to a device, a physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein.

Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

PROCESSOR—Refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

The following numbered examples are embodiments:

1. A method comprising:

receiving, from extensions of multiple network sites, unified input items for a user having user accounts on the multiple network sites, the unified input items comprising one or more parameter fields describing network events on the multiple network sites, the one or more parameter fields being from a set of parameter fields pre-selected for the multiple network sites;

storing the unified input items in a unified database structured for the set parameter fields;

identifying one or more mapped conditional requests having conditions satisfied by the one or more parameter fields in the stored multiple input items, the one or more mapped conditional requests having mappings from the one or more parameter fields to network requests configured for application programing interfaces (APIs) of different external network sites on which the user has a user account, each of the APIs configured to receive differently structured network requests;

responsive to the conditions being satisfied by the one or more parameter fields, generating one or more network requests according to the mappings; and

transmitting the one or more network requests to the different external network sites.

2. The method of example 1, further comprising:

causing presentation of a user interface (UI) for generating mapped conditional requests, the UI comprising a linking window element for linking a condition from a set of conditions to a parameter from the set of parameters pre-selected for the multiple network sites, the UI further comprising a request window element for specifying a mapped request to be generated upon a specified parameter of a mapped conditional request satisfying a specified condition, the specified parameter and specified condition being linked using the linking window element.

3. The method of example 1-2, wherein the UI comprises a button to generate further request window elements for specifying further mapped requests to be generated in response to the specified parameter satisfying the specified condition.

4. The method of example 1-3, wherein identifying the one or more mapped conditional requests having conditions satisfied by the one or more parameter fields comprises:

determining that at least one of the parameter fields of one of the multiple unified input items matches a parameter field specified by a stored mapped conditional request;

identifying the linked condition for the parameter field of the stored mapped conditional request; and

determining that the linked condition is satisfied by the one of the parameter fields.

5. The method of example 1-4, wherein generating the one or more network requests further comprises:

identifying a mapping of the stored mapped conditional request; and

generating at least one network request using the mapping and one or more parameter fields of the multiple unified input items having the matching parameter field.

6. The method of example 1-5, further comprising:

generating a user interface (UI) for selecting an active set of mapped conditional requests, the UI comprising a selector element for each of a plurality of stored mapped conditional requests; and generating an active set of mapped conditional requests in response to selections of one or more selector elements received through the UI.

7. The method of example 1-6, wherein identifying the one or more mapped conditional requests having conditions satisfied by the one or more parameter fields comprises:

determining whether any parameter fields in the stored multiple unified input items match any parameter fields of the active set of mapped conditional requests.

8. The method of example 1-7, wherein generating the one or more network requests further comprises:

generating network requests of mapped conditional requests in the active set that have matched parameter fields, the network requests generated according to mappings of the mapped conditional requests in the active set.

9. The method of example 1-8, wherein each of the one or more network requests transmitted to the different external network sites includes verification data for the user.

10. The method of example 1-9, wherein the verification data is login data of data for the different external network sites.

11. The method of example 1-10, wherein the one or more parameter fields comprise metadata fields and payload fields, the metadata fields describing network communication parameters of the unified input items, the payload fields comprising message data generated by the network sites.

12. The method of example 1-11, wherein the linking window element is operable to select a metadata field or a payload field as a subject of a linked condition.

13. The method of example 1-12, wherein the one or more parameter fields comprises a custom tag field generated by an extension in one of the networks sites, the custom tag field comprising a pre-specified tag; and

wherein the linking window element is operable to select the custom tag field as a subject of a linked condition.

14. The method of example 1-13, wherein the conditions of the one or more mapped conditional requests is at least one of: a match condition, a greater than condition, a less than condition, a within condition.

15. The method of example 1-14, wherein one or more of the extensions are plugins integrated into the multiple network sites.

16. The method of example 1-15, wherein one or more of the extensions are external adapters that request data items from APIs of the multiple network sites to construct the unified input items.

17. The method of example 1-16, wherein the one or more network requests includes multiple sequential network requests configured for sequential execution on one of the different external network sites.

18. The method of example 1-17, wherein the one or more network requests include: a first network request configured for execution on a first network site of the different external network sites, and a second network request configured for execution on a second network site of the different external network sites.

19. A system comprising:

one or more processors of a machine; and

a memory storing instructions that, when executed by the one or more processors, cause the machine to perform any of the methods of examples 1-18.

20. A non-transitory machine-readable storage device embodying instructions that, when executed by a machine, cause the machine to perform any of the methods of examples 1-18.

1. A method comprising:
receiving, from extensions of multiple network sites, unified input items associated with a user having user accounts on the multiple network sites, the unified input items each comprising a parameter field describing a network event of one of the multiple network sites, the parameter field being pre-selected from a set of parameter fields for the multiple network sites;
storing the unified input items in a unified database structured for the set of parameter fields;
identifying one or more mapped conditional requests having conditions satisfied by parameter fields in the stored unified input items, the one or more mapped conditional requests each having a mapping from the parameter field to a network request configured for an application programing interface (API) of one of a plurality of different external network sites on which the user has a user account, each API of the plurality of different external network sites configured to receive differently structured network requests;
responsive to the conditions being satisfied by the parameter fields, generating one or more network requests according to the mappings; and
transmitting, using one or more processors of a machine, the one or more network requests to the different external network sites.

2. The method of claim 1, further comprising:
causing presentation of a user interface (UI) for generating the mapped conditional requests, the UI comprising a linking window element for linking a condition from a set of conditions to a parameter from the set of parameter fields pre-selected for the multiple network sites.

3. The method of claim 2, wherein the UI further comprises a request window element for specifying a mapped request to be generated in response to a specified parameter of a mapped conditional request satisfying a specified condition, the specified parameter and specified condition being linked using the linking window element, wherein the UI comprises a selectable element to generate further request window elements for specifying further mapped requests to be generated in response to the specified parameter satisfying the specified condition.

4. The method of claim 1, wherein identifying the one or more mapped conditional requests having conditions satisfied by parameter fields comprises:
determining that at least one of the parameter fields of one of the unified input items matches a parameter field specified by a stored mapped conditional request;
identifying the linked condition for the parameter field of the stored mapped conditional request; and
determining that the linked condition is satisfied by the at least one of the parameter fields.

5. The method of claim 4, wherein generating the one or more network requests further comprises:
identifying a mapping of the stored mapped conditional request; and
generating at least one network request using the mapping and one or more parameter fields of the multiple unified input items having the matching parameter field.

6. The method of claim 1, further comprising:
generating a user interface (UI) for selecting an active set of mapped conditional requests, the UI comprising a selector element for each of a plurality of stored mapped conditional requests; and
generating an active set of mapped conditional requests in response to selections of one or more selector elements received through the UI.

7. The method of claim 6, wherein identifying the one or more mapped conditional requests having conditions satisfied by parameter fields comprises:
determining whether any parameter fields in the stored unified input items match any parameter fields of the active set of mapped conditional requests.

8. The method of claim 7, wherein generating the one or more network requests further comprises:
generating network requests of mapped conditional requests in the active set that have matched parameter fields, the network requests generated according to mappings of the mapped conditional requests in the active set.

9. The method of claim 1, wherein each of the one or more network requests transmitted to the different external network sites includes verification data for the user.

10. The method of claim 9, wherein the verification data is login data for the different external network sites.

11. The method of claim 1, wherein the one or more parameter fields comprise metadata fields and payload fields, the metadata fields describing network communication parameters of the unified input items, the payload fields comprising message data generated by the network sites.

12. The method of claim 2, wherein the linking window element is operable to select a metadata field or a payload field as a subject of a linked condition.

13. The method of claim 2, wherein the one or more parameter fields comprises a custom tag field generated by one of the extensions in one of the network sites, the custom tag field comprising a pre-specified tag; and
wherein the linking window element is operable to select the custom tag field as a subject of a linked condition.

14. The method of claim 1, wherein the conditions of the one or more mapped conditional requests is at least one of: a match condition, a greater than condition, a less than condition, or a within condition.

15. The method of claim 1, wherein one or more of the extensions are plugins integrated into the multiple network sites.

16. The method of claim 1, wherein one or more of the extensions are external adapters that request data items from APIs of the multiple network sites to construct the unified input items.

17. The method of claim 1, wherein the one or more network requests includes multiple sequential network requests configured for sequential execution on one of the different external network sites.

18. The method of claim 1, wherein the one or more network requests comprises:
a first network request configured for execution on a first network site of the different external network sites, and a second network request configured for execution on a second network site of the different external network sites.

19. A system comprising:
one or more processors of a machine; and
a memory storing instructions that, when executed by the one or more processors, cause the machine to perform operations comprising:
receiving, from extensions of multiple network sites, unified input items associated with a user having user accounts on the multiple network sites, the unified input items each comprising a parameter field describing a network event one of the multiple network sites, the parameter field being pre-selected from a set of parameter fields for the multiple network sites;
storing the unified input items in a unified database structured for the set parameter fields;
identifying one or more mapped conditional requests having conditions satisfied by parameter fields in the stored unified input items, the one or more mapped conditional requests each having a mapping from the parameter field to a network request configured for an application programing interface (API) of one of a plurality of different external network sites on which the user has a user account, each API of the plurality of different external network sites configured to receive differently structured network requests;
responsive to the conditions being satisfied by parameter field, generating one or more of the network requests according to the mappings; and
transmitting the one or more of the network requests to the different external network sites.

20. A machine-readable medium embodying instructions that, when executed by a machine, cause the machine to perform operations comprising:
receiving, from extensions of multiple network sites, unified input items associated with a user having user accounts on the multiple network sites, the unified input items each comprising a parameter field describing a network event one of the multiple network sites, the parameter field being pre-selected from a set of parameter fields for the multiple network sites;
storing the unified input items in a unified database structured for the set parameter fields;
identifying one or more mapped conditional requests having conditions satisfied by parameter fields in the stored unified input items, the one or more mapped conditional requests each having a mapping from the parameter field to a network request configured for an application programing interface (API) of one of a plurality of different external network sites on which the user has a user account, each API of the plurality of different external network sites configured to receive differently structured network requests;
responsive to the conditions being satisfied by parameter field, generating one or more of the network requests according to the mappings; and
transmitting the one or more of the network requests to the different external network sites.
